(19) United States
(12) Patent Application Publication
(10) Pub. No.: US 2014/0176414 A1
(43) Pub. Date: Jun. 26, 2014

(54) DRIVING METHOD OF ELECTRO-OPTICAL DEVICE, DRIVING DEVICE, ELECTRO-OPTICAL DEVICE AND ELECTRONIC EQUIPMENT

(71) Applicant: Seiko Epson Corporation, Tokyo (JP)

(72) Inventor: Shinta Enami, Chino-shi (JP)

(73) Assignee: Seiko Epson Corporation, Tokyo (JP)

(21) Appl. No.: 14/101,846

(22) Filed: Dec. 10, 2013

(30) Foreign Application Priority Data
Dec. 20, 2012 (JP) 2012-277753

(51) Int. Cl. G09G 3/34

(52) U.S. Cl. CPC G09G 3/344
USPC 345/107

(57) ABSTRACT

In an electro-optical device including pixels 48, one frame image includes a first field image and a second field image, in a scanning signal forming the first field image, a clock signal CLY switches from a high potential to a low potential during the selection state period, and in a scanning signal forming the second field image, the clock signal CLY switches from a low potential to a high potential during the selection state period. Since the switching direction of the clock signal CLY is opposite between the first field image and the second field image, it is possible to cancel out influence of the clock signal switching in the first field image and the second field image, and the image quality improves.

### BACKGROUND

1. Technical Field

The present invention relates to a driving method of an electro-optical device, a driving device, an electro-optical device, and electronic equipment.

2. Related Art

In electronic equipment with a display function, a transmissive-type electro-optical device or reflective-type electro-optical device is used. Light is irradiated on these electro-optical devices, and transmitted light or reflected light modulated by the electro-optical device becomes a display image; or becomes a projected image by being projected on a screen. A liquid crystal device is known as an electro-optical device in which such electronic equipment is used, and is a device forming an image by using dielectric anisotropy of a liquid crystal and optical rotation of light in a liquid crystal layer. In the liquid crystal device, scanning lines and signal lines are arranged in an image display region, and pixels are arranged in a matrix form at the intersections thereof. A pixel transistor is provided in the pixel, and an image is formed by supplying image signals to each pixel via the pixel transistor.

In obtaining a stereoscopic video image (three-dimensional video image) or a video image with a high display quality with electronic equipment in which a display function is provided, there is a need for a liquid crystal device displaying a high definition image at high speeds. A method of high speed display of such a high definition image is disclosed in JP-A-2012-49645. In JP-A-2012-49645, a second image with a low resolution is displayed by selecting every other scanning line, after a first image with a low resolution is displayed by selecting two scanning lines, and a high resolution image is formed by matching the first image with the second image.

However, there is a problem in that the quality of a displayed image is low in the display method disclosed in JP-A-2012-49645. Specifically, in a case in which the display method disclosed in JP-A-2012-49645 is employed, a vertical band in which the brightness changes in the vicinity of the center in the horizontal direction of the display region is generated. In other words, in the driving method of an electro-optical device of the related art, there is a problem in that it is difficult to achieve both high speed display of a high definition image and a high resolution video image.

### SUMMARY

The invention can be realized in the following forms or application examples.

### Application Example 1

According to this application example, there is provided a driving method of an electro-optical device which includes a pixel and a scanning line driving circuit supplying a scanning signal to the pixel in which the scanning signal has a selection state and a non-selection state, the scanning line driving circuit generates a scanning signal using a clock signal in which a low potential and a high potential are repeated, one frame image includes a first field image and a second field image, the clock signal switches from the high potential to the low potential during the period of the selection state in the scanning signal forming the first field image, and the clock signal switches from the low potential to the high potential in the period of the selection state in the scanning signal forming the second field image.

According to this method, since the switching direction of the clock signal is opposite between the first field image and the second field image, it is possible to cancel out influence of the clock signal switching in the first field image and the second field image. Accordingly, an occurrence of a vertical band in which the brightness changes in the vicinity of the center in the horizontal direction of the display regions is suppressed, and the image quality improves.

### Application Example 2

According to this application example, there is provided a driving method of an electro-optical device which includes a pixel and a scanning line driving circuit supplying a scanning signal to the pixel, in which the scanning signal has a selection state and a non-selection state, the scanning line driving circuit generates a scanning signal using a clock signal in which a low potential and a high potential are repeated, one frame image includes a first field image and a second field image, the clock signal switches from the low potential to the high potential during the period of the selection state in the scanning signal forming the first field image, and the clock signal switches from the high potential to the low potential in the period of the selection state in the scanning signal forming the second field image.

According to this method, since the switching direction of the clock signal is opposite between the first field image and the second field image, it is possible to cancel out influence of the clock signal switching in the first field image and the second field image. Accordingly, a vertical band in which the brightness changes in the vicinity of the center in the horizontal direction of the display regions is suppressed, and the image quality improves.

### Application Example 3

In the driving method of the electro-optical device according to the above application example 1 or 2, it is preferable that the electro-optical device include scanning lines electrically connected to a scanning line driving circuit, a first field image be formed using a line pair scanning in which each line pair is selected, with a set of two adjacent scanning lines of the scanning lines as a line pair, and a second field image be formed using a shifted line pair scanning in which each shifted line pair is selected with a set of scanning lines different from the line pair having two adjacent scanning lines of the scanning lines as a shifted line pair.

According to this method, since the switching direction of the clock signal is opposite between the first field image and the second field image, it is possible to cancel out influence of the clock signal switching in the first field image and the second field image. Accordingly, a vertical band in which the brightness changes in the vicinity of the center in the horizontal direction of the display regions is suppressed, and the image quality improves. Further, since the two scanning lines are selected between the first field image and the second field image, it is possible to display a high definition image in a short time. In other words, it is possible to achieve both high speed display of a high definition image and a high quality video image.

### Application Example 4

According to this application example, there is provided a driving method of an electro-optical device which includes a first scanning line, and a first pixel connected to the first scanning line; a second scanning line adjacent to the first scanning line, and a second pixel connected to the second scanning line; a third scanning line adjacent to the second scanning line, and a third pixel connected to the third scanning line; a fourth scanning line adjacent to the third scanning line, and a fourth pixel connected to the fourth scanning line; a fifth scanning line adjacent to the fourth scanning line, and a fifth pixel connected to the fifth scanning line; and signal lines supplying image signals to the first pixel, the second pixel, the third pixel, the fourth pixel and the fifth pixel, in which a frame image configuring one frame includes a first field image and a second field image; the first field image is formed by setting the first scanning line and the second scanning line to the selection state, and supplying a first image signal corresponding to the first pixel to the first pixel and the second pixel, in a first selection period, and by setting the third scanning line and the fourth scanning line to a selection state, and supplying a third image signal corresponding to the third pixel to the third pixel and the fourth pixel in a second selection period subsequent to the first selection period; the second field image is formed by setting the second scanning line and the third scanning line to the selection state and supplying a second image signal corresponding to the second pixel to the second pixel and the third pixel in a third selection period, and by setting the fourth scanning line and the fifth scanning line to the selection state and supplying an image signal corresponding to the fourth pixel to the fourth pixel and the fifth pixel in a fourth selection period subsequent to the third selection period, the selection state is generated according to a clock signal in which a low potential and a high potential are repeated; the clock signal switches from the high potential to the low potential in the first selection period and the second selection period, and the clock signal switches from the low potential to the high potential in the third selection period and the fourth selection period.

According to this method, since the switching direction of the clock signal is opposite between the first field image and the second field image, it is possible to cancel out influence of the clock signal switching in the first field image and the second field image. Accordingly, a vertical band in which the brightness changes in the vicinity of the center in the horizontal direction of the display regions is suppressed, and the image quality improves. Further, since the two scanning lines are selected between the first field image and the second field image, it is possible to display a high definition image in a short time. In other words, it is possible to achieve both high speed display of a high definition image and a high quality video image.

### Application Example 5

According to this application example, there is provided a driving method of an electro-optical device which includes a first scanning line, and a first pixel connected to the first scanning line; a second scanning line adjacent to the first scanning line, and a second pixel connected to the second scanning line; a third scanning line adjacent to the second scanning line, and a third pixel connected to the third scanning line; a fourth scanning line adjacent to the third scanning line, and a fourth pixel connected to the fourth scanning line; a fifth scanning line adjacent to the fourth scanning line, and a fifth pixel connected to the fifth scanning line; and signal lines supplying image signals to the first pixel, the second pixel, the third pixel, the fourth pixel and the fifth pixel, in which a frame image configuring one frame includes a first field image and a second field image; the first field image is formed by setting the first scanning line and the second scanning line to the selection state, and by supplying a first image signal corresponding to the first pixel to the first pixel and the second pixel, in a first selection period, and setting the third scanning line and the fourth scanning line to a selection state, and by supplying a third image signal corresponding to the third pixel to the third pixel and the fourth pixel in a second selection period subsequent to the first selection period; the second field image is formed by setting the second scanning line and the third scanning line to the selection state and supplying a second image signal corresponding to the second pixel to the second pixel and the third pixel in a third selection period, and setting the fourth scanning line and the fifth scanning line to the selection state and by supplying an image signal corresponding to the fourth pixel to the fourth pixel and the fifth pixel in a fourth selection period subsequent to the third selection period, the selection state is generated according to a clock signal in which a low potential and a high potential are repeated; the clock signal switches from the low potential to the high potential in the first selection period and the second selection period, and the clock signal switches from the high potential to the low potential in the third selection period and the fourth selection period.

According to this method, since the switching direction of the clock signal is opposite between the first field image and the second field image, it is possible to cancel out influence of the clock signal switching in the first field image and the second field image. Accordingly, a vertical band in which the brightness changes in the vicinity of the center in the horizontal direction of the display regions is suppressed, and the image quality improves. Further, since the two scanning lines are selected between the first field image and the second field image, it is possible to display a high definition image in a short time. In other words, it is possible to achieve both high speed display of a high definition image and a high quality video image.

### Application Example 6

In the driving method of an electro-optical device according to the above application example 1 or 2, it is preferable that scanning lines electrically connected to a scanning line driving circuit be included, and the first field image be formed using shifted line pair scanning in which each shifted line pair is selected with a set of two adjacent scanning lines of the scanning lines as a shifted line pair, and the second field image be formed using interlaced scanning in which every other scanning line is selected.

According to this method, since the switching direction of the clock signal is opposite between the first field image and the second field image, it is possible to cancel out influence of the clock signal switching in the first field image and the second field image. Accordingly, a vertical band in which the brightness changes in the vicinity of the center in the horizontal direction of the display regions is suppressed, and the image quality improves. Furthermore, since the two scanning lines are selected in the first field image and every other scanning line is selected in the second field image, it is possible to display a high definition image in a short time. In other words, it is possible to achieve both high speed display of a high definition image and a high quality video image.

### Application Example 7

According to this application example, there is provided a driving method of an electro-optical device which includes a first scanning line, and a first pixel connected to the first scanning line; a second scanning line adjacent to the first scanning line, and a second pixel connected to the second scanning line; a third scanning line adjacent to the second scanning line, and a third pixel connected to the third scanning line; a fourth scanning line adjacent to the third scanning line, and a fourth pixel connected to the fourth scanning line; a fifth scanning line adjacent to the fourth scanning line, and a fifth pixel connected to the fifth scanning line; and signal lines supplying image signals to the first pixel, the second pixel, the third pixel, the fourth pixel and the fifth pixel, in which a frame image configuring one frame includes a first field image and a second field image; the first field image is formed by setting the second scanning line and the third scanning line to the selection state, and supplying a second image signal corresponding to the second pixel to the second pixel and the third pixel, in a selection period −1, and setting the fourth scanning line and the fifth scanning line to a selection state, and by supplying an image signal corresponding to the fourth pixel to the fourth pixel and the fifth pixel in a selection period −2 subsequent to the selection period −1; the second field image is formed by setting the first scanning line to the selection state and supplying a first image signal corresponding to the first pixel to the first pixel in a selection period −3, and setting the third scanning line to the selection state and by supplying an image signal corresponding to the third pixel to the third pixel in a selection period −4 subsequent to the selection period −3, the selection state is generated according to a clock signal in which a low potential and a high potential are repeated; the clock signal switches from the high potential to the low potential in the selection period −3 and the selection period −4, and the clock signal switches from the low potential to the high potential in the selection period −1 and the selection period −2.

According to this method, since the switching direction of the clock signal is opposite between the first field image and the second field image, it is possible to cancel out influence of the clock signal switching in the first field image and the second field image. Accordingly, a vertical band in which the brightness changes in the vicinity of the center in the horizontal direction of the display regions is suppressed, and the image quality improves. Furthermore, since the two scanning lines are selected in the first field image and every other scanning line is selected in the second field image, it is possible to display a high definition image in a short time. In other words, it is possible to achieve both high speed display of a high definition image and a high quality video image.

### Application Example 8

According to this application example, there is provided a driving method of an electro-optical device which includes a first scanning line, and a first pixel connected to the first scanning line; a second scanning line adjacent to the first scanning line, and a second pixel connected to the second scanning line; a third scanning line adjacent to the second scanning line, and a third pixel connected to the third scanning line; a fourth scanning line adjacent to the third scanning line, and a fourth pixel connected to the fourth scanning line; a fifth scanning line adjacent to the fourth scanning line, and a fifth pixel connected to the fifth scanning line; and signal lines supplying image signals to the first pixel, the second pixel, the third pixel, the fourth pixel and the fifth pixel, in which a frame image configuring one frame includes a first field image and a second field image; the first field image is formed by setting the second scanning line and the third scanning line to the selection state, and supplying a second image signal corresponding to the second pixel to the second pixel and the third pixel, in a selection period −1, and setting the fourth scanning line and the fifth scanning line to a selection state, and by supplying an image signal corresponding to the fourth pixel to the fourth pixel and the fifth pixel in a selection period −2 subsequent to the selection period −1; the second field image is formed by setting the first scanning line to the selection state and by supplying a first image signal corresponding to the first pixel to the first pixel in a selection period −3, and setting the third scanning line to the selection state and supplying an image signal corresponding to the third pixel to the third pixel in a selection period −4 subsequent to the selection period −3, the selection state is generated according to a clock signal in which a low potential and a high potential are repeated; the clock signal switches from the low potential to the high potential in the selection period −3 and the selection period −4, and the clock signal switches from the high potential to the low potential in the selection period −1 and the selection period −2.

According to this method, since the switching direction of the clock signal is opposite between the first field image and the second field image, it is possible to cancel out influence of the clock signal switching in the first field image and the second field image. Accordingly, a vertical band in which the brightness changes in the vicinity of the center in the horizontal direction of the display regions is suppressed, and the image quality improves. Furthermore, since the two scanning lines are selected in the first field image and every other scanning line is selected in the second field image, it is possible to display a high definition image in a short time. In other words, it is possible to achieve both high speed display of a high definition image and a high quality video image.

### Application Example 9

According to this application example, there is provided a driving device realizing the driving method of an electro-optical device according to any one of the application examples 1 to 8, in which a signal is supplied to the electro-optical device.

According to this configuration, it is possible to supply a signal displaying a high quality video image at high speed to an electro-optical device.

### Application Example 10

According to this application example, there is provided an electro-optical device driven by the driving method of an electro-optical device according to any of the application examples 1 to 8.

According to the configuration, it is possible to realize an electro-optical device displaying a high quality video image at high speeds.

### Application Example 11

According to this application example, there is provided electronic equipment including the electro-optical device according to application example 10.

According to the configuration it is possible to realize electronic equipment displaying a high resolution video image at high speeds.

### BRIEF DESCRIPTION OF THE DRAWINGS

The invention will be described with reference to the accompanying drawings, wherein like numbers reference like elements.

FIG. 1 is a schematic diagram of a projection-type display device (3-plate type projector) that is an example of electronic equipment.

FIG. 2 is a circuit configuration diagram of an item of electronic equipment.

FIG. 3 is a circuit diagram of a pixel.

FIG. 4 is a circuit configuration diagram of a scanning line driving circuit.

FIG. 5A is a diagram describing various signals and display images supplied to an electro-optical device when forming a line pair image in Embodiment 1.

FIG. 5B is a diagram describing various signals and display images supplied to an electro-optical device when forming a line pair image in Embodiment 1.

FIG. 6A is a diagram describing various signals and display images supplied to an electro-optical device when forming a shifted line pair image in Embodiment 1.

FIG. 6B is a diagram describing various signals and display images supplied to an electro-optical device when forming a shifted line pair image in Embodiment 1.

FIG. 7 is a diagram describing a method of displaying a three-dimensional image with an item of electronic equipment.

FIG. 8A is a diagram describing various signals and display images supplied to an electro-optical device when forming an interlaced image in Embodiment 2.

FIG. 8B is a diagram describing various signals and display images supplied to an electro-optical device when forming an interlaced image in Embodiment 2.

FIG. 9 is a diagram describing a method of displaying a three-dimensional image with an item of electronic equipment.

### DESCRIPTION OF EXEMPLARY EMBODIMENTS

Below, embodiments of the present invention will be described with reference to the drawings. Moreover, in each of the drawings below, because each of the layer and members is made to a visually recognizable size, the measurements of each layer and member are different in practice.

### Embodiment 1

### Overview of Electronic Equipment

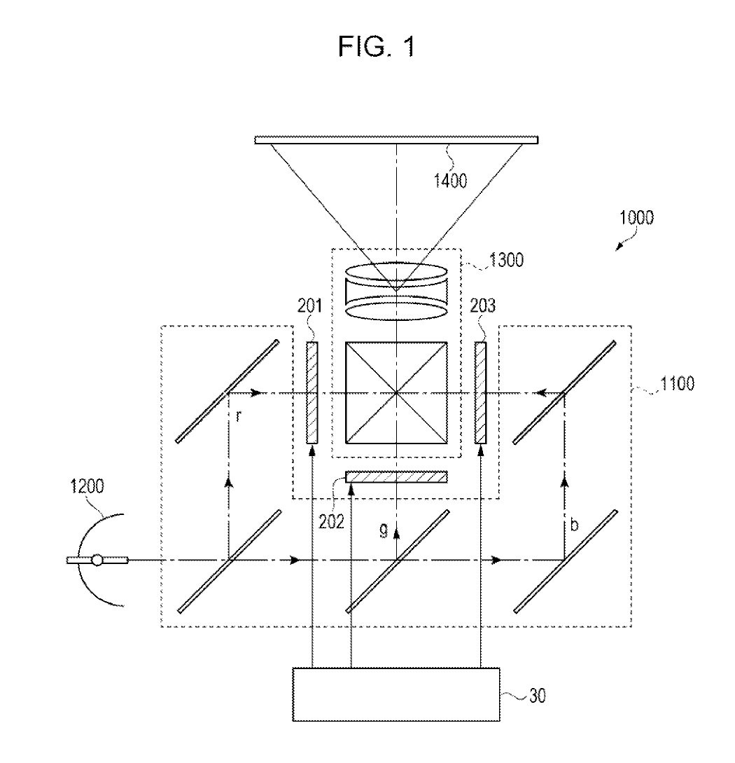

FIG. 1 is a schematic diagram of a projection-type display device (3-plate type projector) that is an example of an item of electronic equipment. Below, a configuration of electronic equipment will be described with reference to FIG. 1.

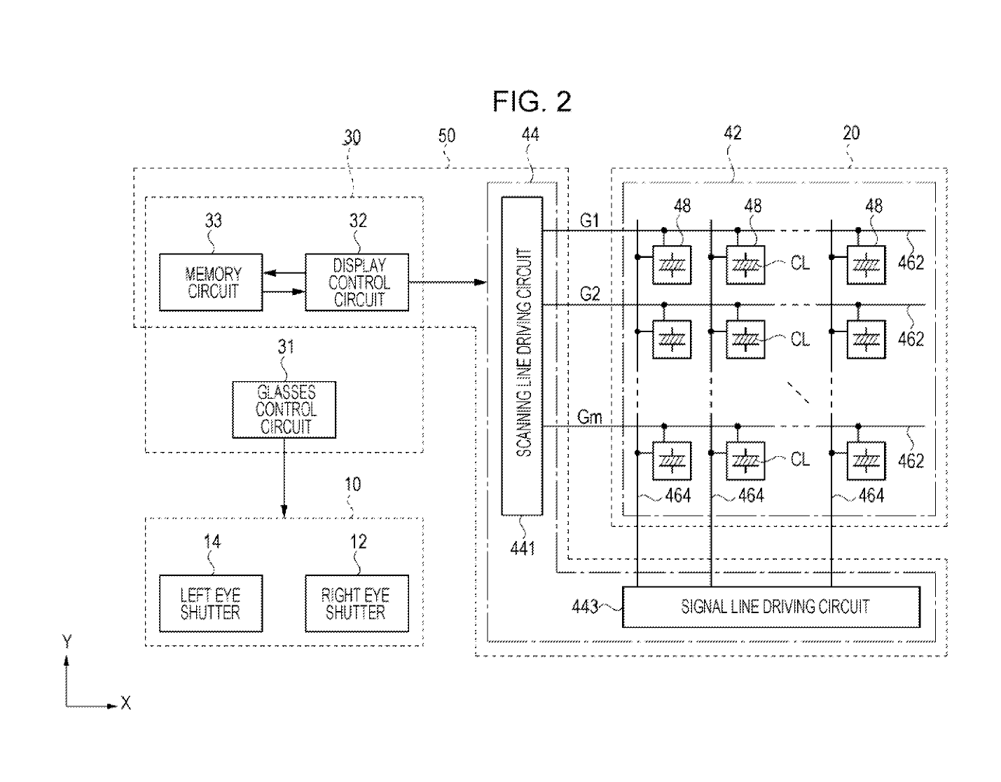

The electronic equipment (projection-type display device 1000) has at least three electro-optical devices 20 (refer to FIG. 2, below, referred to as first panel 201, second panel 202, and third panel 203), and a control device 30 supplying a control signal to these electro-optical devices 20. The first panel 201, second panel 202, and third panel 203 are three electro-optical devices 20 corresponding to display colors different from one another (red, green, and blue). Below, if there is no particular need to differentiate the first panel 201, second panel 202, and third panel 203, these will simply be referred to collectively as the electro-optical device 20.

The illumination optical system 1100 supplies a red component r to the first panel 201, supplies a green component g to the second panel 202, and supplies a blue component b to the third panel 203 from light emitted from the illumination device (light source) 1200. Each electro-optical device 20 functions as an optical modulator (light valve) modulating each color of light supplied from the illumination optical system 1100 according to a display image. A projection optical system 1300 synthesizes light emitted from the electro-optical devices 20 and project the light on a projection surface 1400.

### Circuit Configuration of Electronic Equipment

FIG. 2 is a circuit configuration diagram of an item of electronic equipment. Next, a circuit configuration of the electronic equipment will be described with reference to FIG. 2.

The electronic equipment according to the present embodiment is able to display a stereoscopic image in which a stereoscopic effect is perceived by the observer in a frame sequential method is used. As shown in FIG. 2, the electronic equipment is equipped with at least stereoscopic viewing glasses 10, electro-optical devices 20, and a driving device 50. The electronic equipment includes a glasses control circuit 31 controlling the stereoscopic viewing glasses 10 in addition thereto.

The stereoscopic viewing glasses 10 are an appliance in the forms of glasses worn by an observer when viewing a stereoscopic image displayed by the electro-optical devices 20, and are configured to include a right eye shutter 12 positioned in front of the right eye of the observer and a left eye shutter 14 positioned in front of the left eye. Each of the right eye shutter 12 and the left eye shutter 14 controls an open state in which irradiated light is allowed to transmit, and a closed state in which irradiated light is blocked. For example, a liquid crystal shutter changing from one of the open state and the closed state to the other according to the alignment direction of the liquid crystal according to an applied voltage is employable as the right eye shutter 12 and the left eye shutter 14.

The electro-optical device 20 includes a display region 42 in which a plurality of pixels 48 is arranged. Mutually intersecting scanning lines 462 and signal lines 464 are formed in the display region 42. The scanning lines 462 extend in the row direction and the signal lines 464 extend in the column direction. Moreover, in cases where the i-th row of the scanning lines 462 is specified in the scanning lines 462, this is denoted by scanning line G1. Each pixel 48 is arranged in a matrix form corresponding to each intersection of the scanning lines 462 and signal lines 464. In the electro-optical device 20, a display region 42 including m scanning lines 462 and n signal lines 464 (m is an integer of 3 or more, and n is an integer of 1 or more) is formed.

The electro-optical device 20 is driven by a driving device 50. The driving device 50 is configured to include a driving circuit 44 driving each pixel 48, a display control circuit 32 supplying control signals to the driving circuit 44, and a memory circuit 33 temporarily storing frame images. As described later, since one frame image configuring one frame includes a first field image and a second field image, the display control circuit 32 creates a control signal that is a first field image and a second field image from a frame image stored in the memory circuit 33, and supplies these to the driving circuit 44. The driving circuit 44 is configured to include a scanning line driving circuit 441 and a signal line driving circuit 443. The scanning line driving circuit 441 outputs scanning signals selecting or not selecting pixels in the row direction to each scanning line 462, and the scanning lines 462 transfers these scanning signals to the pixels 48. In other words, the scanning signal has a selection state and a non-selection state, and the scanning lines 462 are sequentially selectable by receiving the scanning signals by the scanning line driving circuit 441. The scanning line driving circuit 443 supplies image signals Vij to each of the n signal lines 464 by synchronization to the selection of the scanning lines 462. Here, i is an integer from 1 to m, and j is an integer from 1 to n. An image signal Vij is supplied to the pixel 48 positioned at row i and column j.

In this way, the electro-optical device 20 includes, a first scanning line 462, and a first pixel 48 connected to the first scanning line 462; a second scanning line adjacent to the first scanning line 462, and a second pixel 48 connected to the second scanning line 462; a third scanning line 462 adjacent to the second scanning line 462, and a third pixel 48 connected to the third scanning line 462; a fourth scanning line 462 adjacent to the third scanning line 462, and a fourth pixel 48 connected to the fourth scanning line 462; a fifth scanning line 462 adjacent to the fourth scanning line 462, and a fifth pixel 48 connected to the fifth scanning line 462; and signal lines supplying image signals to the first pixel 48, the second pixel 48, the third pixel 48, the fourth pixel 48, and the fifth pixel 48. For example, if the first scanning line 462 is the scanning line G5 of the fifth row, the second scanning line 462 is the scanning line G6 of the sixth row, the third scanning line 462 is the scanning line G7 of the seventh row, the fourth scanning line 462 is the scanning line G8 of the eighth row, and the fifth scanning line 462 is the scanning line G9 of the ninth row. In the example in this case, the first pixel 48 is n pixels 48 positioned in the fifth row and j-th column (j is an integer from 1 to n), the second pixel 48 is n pixels 48 positioned in the sixth row and j-th column, the third pixel 48 is n pixels 48 positioned in the seventh row and j-th column, the fourth pixel 48 is n pixels 48 positioned in the eighth row and j-th column, and the fifth pixel 48 is n pixels 48 positioned in the ninth row and j-th column. In the first scanning line 462, it is possible to determine one arbitrary scanning line 462 from among the scanning line G1 of the first row to the scanning line Gm−4 of the m−4 row.

Moreover, in the present embodiment, the electro-optical device 20 is formed using a glass substrate not shown in the drawings, and the driving circuit 44 is formed on the glass substrate using a thing film element, such as a thin film transistor. In addition, the glasses control circuit 31, display control circuit 32, and memory circuit 33 form the control device 30. Even in other configurations, the electro-optical device 20 may be formed using a glass substrate, the driving circuit 44 may be an integrated circuit formed on a single crystal semiconductor substrate, and the electro-optical device 20 and the driving circuit 44 may also be configured to be formed on a single crystal semiconductor substrate. In addition, a configuration in which the glasses control circuit 31, the display control circuit 32, and the memory circuit 33 are mounted to a stand-alone integrated circuit, a configuration in which two of these circuits are mounted to a stand-alone integrated circuit, or a configuration in which the display control circuit 32, the glasses control circuit 31 and the memory circuit 33 are distributed to separate integrated circuits may be employed.

### Configuration of Pixel

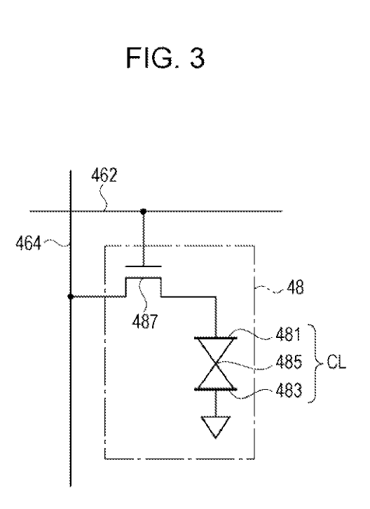

FIG. 3 is a circuit diagram of each pixel. Next the configuration of a pixel 48 will be described with reference to FIG. 3.

The electro-optical device 20 of the present embodiment is a liquid crystal device, and the electro-optical material is a liquid crystal 485.

As shown in FIG. 3, each pixel 48 is configured to include a liquid crystal element CL and a selection switch 487. The liquid crystal element CL has a pixel electrode 481 and a common electrode 483 opposing each other, and is an electro-optical element in which a liquid crystal 485 as an electro-optical material is arranged between both electrodes. The transmissivity of light passing through the liquid crystal 485 changes according to the electric field applied between the pixel electrode 481 and the common electrode 483.

The selection switch 487 is formed by an N-channel thin film transistor in which a gate is connected to the scanning line 462, and controls electrical connection (connection/disconnection) of both interposed between the liquid crystal element CL and the signal line 464. Accordingly, the pixel 48 (liquid crystal element CL) displays a gradation corresponding to the potential (image signal Vij) of the signal line 464 when the selection switch 487 is controlled to the on state. Moreover, an auxiliary capacitance, or the like, connected in parallel with respect to the liquid crystal element CL is not shown in the drawings.

### Scanning Line Driving Circuit

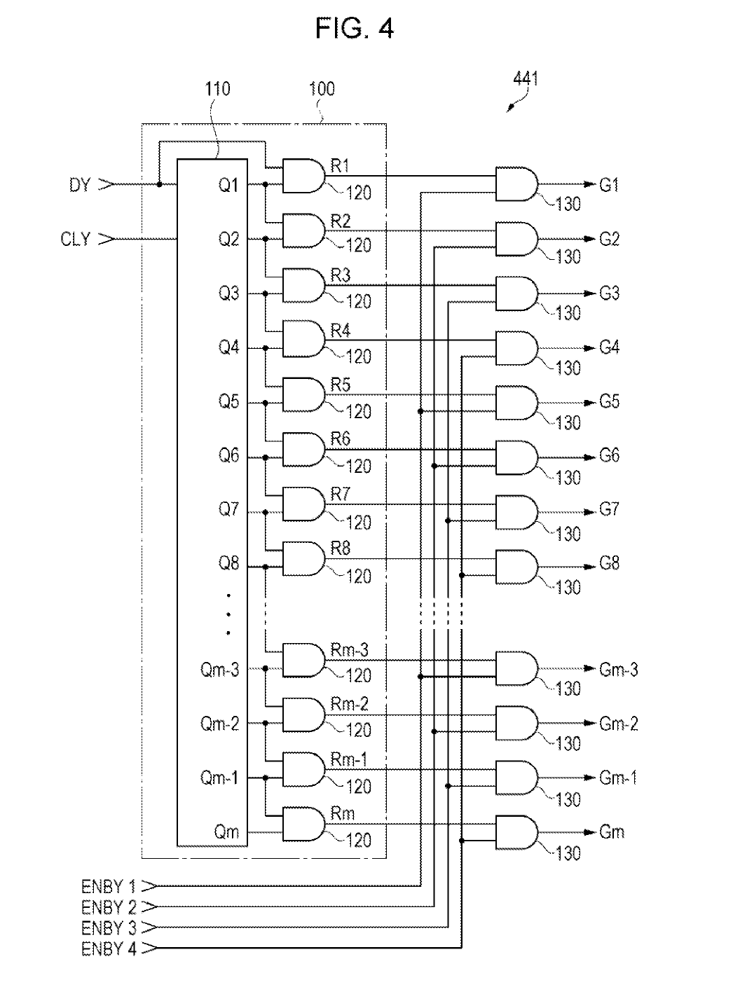

FIG. 4 is a circuit configuration diagram of a scanning line driving circuit. Next, the configuration of the scanning line driving circuit 441 will be described with reference to FIG. 4.

The scanning line driving circuit 441 includes a circuit which, along with executing progressive scanning selecting one scanning line 462 at a time from the m scanning lines 462, is able to execute line pair scanning in which each line pair is selected with a set of two adjacent scanning lines 462 from m scanning lines 462 as a line pair, or, is able to execute shifted line pair scanning with two adjacent scanning lines 462 from m scanning lines 462, with a set of scanning lines 462 in which the combined scanning lines 462 are shifted by one line pair as a shifted line pair, and furthermore, executes interlaced scanning in which every other scanning line 462 is selected from m scanning lines 462. Moreover, an image formed using line pair scanning is referred to as a line pair image, an image formed using shifted line pair scanning is referred to as a shifted line pair image, and an image formed using interlaced scanning is referred to as an interlaced image.

Progressive scanning is a scanning method selecting scanning lines 462 one at a time in order, and proceeds by selecting, for example, G1, G2, G3 one at a time in order. Line pair scanning proceeds by pairing and sequentially selecting, for example, the line pair of G1 and G2, the line pair of G3 and G4, the line pair of G5 and G6, and the scanning line 462 of row 2s−1 and the scanning line 462 of row 2s (s is an integer from 1 to m/2). The shifted line pair scanning proceeds by pairing and sequentially selecting, for example, the line pair of G2 and G3, the line pair of G4 and G5, the line pair of G6 and G7, and the scanning line 462 of row 2t and the scanning line 462 of the row 2t+1 (t is an integer from 1 to m/2−1) Interlaced scanning is a scanning method selecting in order and skipping every other scanning line 462, and, for example, proceeds by selecting G1, G3, G5, and the scanning lines 462 of the row 2s−1. Moreover, a given specified scanning line 462 being selected signifies that a scanning signal in the selection state is supplied to the scanning line 462. In addition, non-selection of a given specified scanning line 462 (a given specified scanning line 462 is not selected) signifies that a scanning signal in the non-selection state is supplied to the scanning line 462. In the present embodiment, since an N-type thin film transistor is used in the selection switch 487, the scanning signal in the selection state is a high potential (for example, a positive power source potential Vdd), and the scanning signal in the non-selection state is a low potential (for example, a negative power source potential Vss).

The control signal supplied to the driving circuit 44 from the control device 30 includes a start pulse signal DY supplied to the scanning line driving circuit 441, a clock signal CLY supplied to the scanning line driving circuit 441, and an enable signal supplied to the scanning line driving circuit 441. There are four types of enable signal, which are an enable 1 signal ENBY 1, an enable 2 signal ENBY 2, an enable 3 signal ENBY 3, and an enable 4 signal ENBY 4.

FIG. 4 shows an example of the circuit configuration enabling the above-described scanning methods. The scanning line driving circuit 441 is equipped with a signal generation circuit 100, m second AND circuits 130 corresponding to the number of scanning lines 462. The signal generation circuit 100 is equipped with an m-stage shift register 110 and m first AND circuits 120. A start pulse signal DY, a clock signal CLY or the like is supplied from the display control circuit 32 to the shift register 110.

The shift register 110 outputs transfer pulses Q1, Q2, . . . , Qm by sequentially transferring start pulse signals DY synchronized with the clock signal CLY. The i-th (i=1 to m) first AND circuit 120, outputs the logical product of an early stage transfer pulse Qi−1 (a start pulse signal DY in the first AND circuit 120) and a self-stage transfer pulse Q1 as a control pulse R1. That is, the signal generation circuit 100 sequentially outputs m-system control pulses R1, R2, . . . Rm based on the start pulse signal DY and the clock signal CLY supplied. The i-th second AND circuit 130 outputs the logical product of the control pulse R1 output from the signal generation circuit 100 and the enable p signal ENBYp (p is any one integer from 1 to 4) supplied from the display control circuit 32 as a scanning signal to the scanning line G1 of row i. In a case in which m second AND circuits 130 as a unit of four units neighboring each other is partitioned into a plurality (m/4) of sets, an enable p signal ENBYp is supplied to the p-th (p=1 to 4) second AND circuit 130 in each set. By forming such a circuit configuration, it is possible to perform progressive scanning, line pair scanning, shifted line pair scanning, interlaced scanning or the like.

### First Field Image and Second Field Image

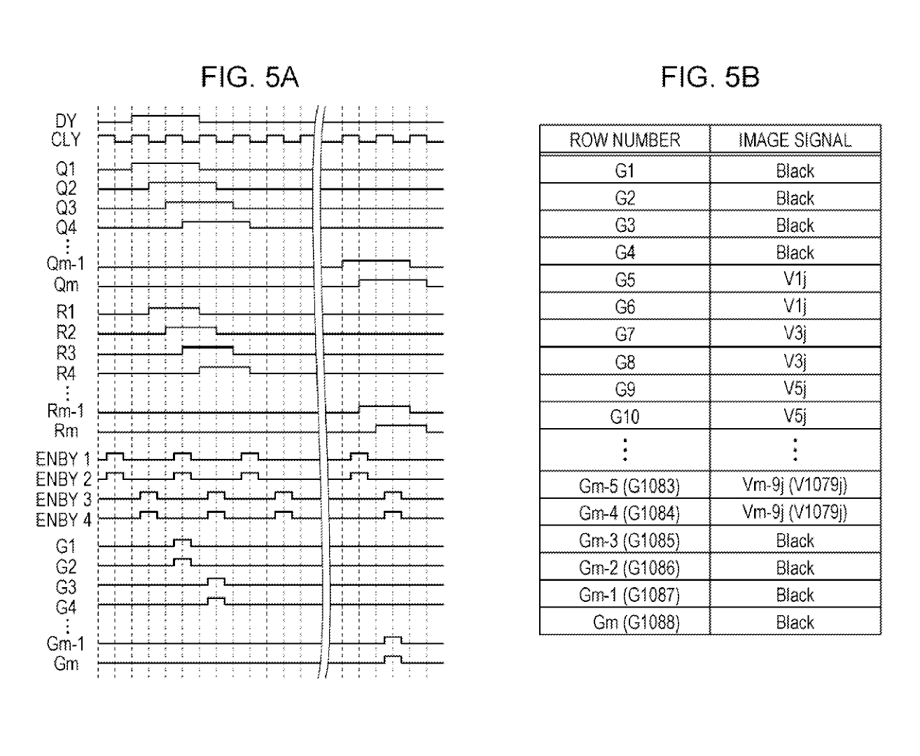

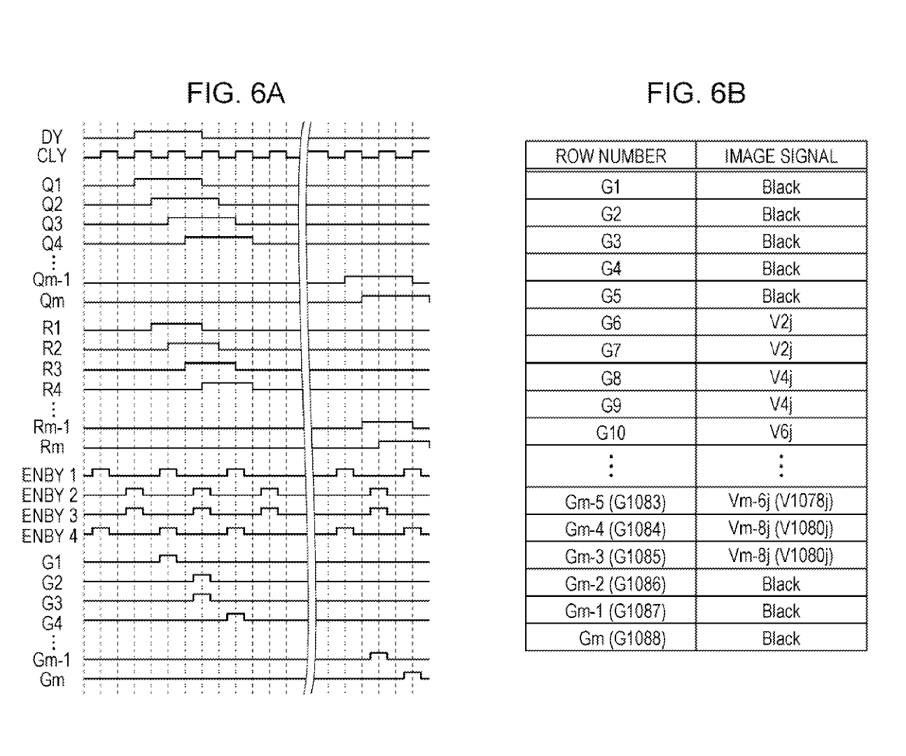

FIGS. 5A and 5B are diagrams describing various signals and display images supplied to an electro-optical device when forming a line pair image in the present embodiment. In addition, FIGS. 6A and 6B are diagrams describing various signals and display images supplied to an electro-optical device when forming a shifted line pair image in the present embodiment. Next, a method of forming the first field image using line pair scanning, and a method of forming the second field image using shifted line pair scanning will be described with reference to FIGS. 5A and 5B and FIGS. 6A and 6B. Moreover, a first field image may be formed using shifted line pair scanning, and a second field image may be formed using line pair scanning. In this case, the first field image may be reread as the second field image and the second field image may be reread as the first field image in the description below.

FIG. 5A is a timing chart of a case of forming a line pair image using line pair scanning and FIG. 5B describes the type of signal supplied to the pixel 48 connected to the scanning line 462 in this case.

FIG. 5B shows an image signal supplied to the signal lines 464 for each row when displaying an odd numbered image on the electro-optical device 20 using line pair scanning. Here, the first field image is an odd numbered image. The odd numbered image is an image formed using an image signal of the odd numbered rows from the images of one frame which are a source (referred to as a frame image, in the present embodiment, a full high vision image of 1080 vertical pixels×1920 horizontal pixels). In other words, an image in which an image displaying odd numbered rows is selected from the frame image is an odd numbered image. In the present embodiment, since there are 1080 pixels in the vertical direction of 1 frame image, an odd numbered image is formed using image signals of the 540 rows worth of odd numbered rows, such as the image signal V1j of the first row of the frame image, the image signal V3j of the third row of the frame image, and the image signal V5j of the fifth row of the frame image. In this case, as shown in FIG. 5B, the same image signal is supplied to the pixels 48 connected to two adjacent scanning lines 462. For example, the image signal V1j of the first row of the frame image is supplied to the pixel 48 connected to the scanning line G5 of the fifth row and the scanning line G6 of the 6th row, the image signal V3j of the third row of the frame image is supplied to the pixel 48 connected to the scanning line G7 of the seventh row and the scanning line G8 of the eighth row, and in the same manner as below, image signal V1079j of the 1079-th row of the frame image is supplied to the pixel 48 connected to the scanning line G1083 of the 1083-rd row and the scanning line G1084 of the 1084-th row. Moreover, the display region 42 of the electro-optical device 20 includes an image region and an adjustment region. The image region is a region in which an image is displayed in actual use, and four scanning lines worth of adjustment region is provided above and below the image regions. An image signal is supplied to the pixels 48 of the image region, and a black signal Black is supplied to the pixels 48 of the adjustment region. In FIG. 5B, the adjustment region is a region in which a pixel 48 is connected to scanning lines 462 from scanning line G1 of the first row to scanning line G4 of the fourth row, and a pixel 48 connected to scanning lines 462 from scanning line Gm−3 of the row m−3 to the scanning line Gm of row m, and the image region is a region in which a pixel 48 connected to scanning lines 462 from scanning line G5 of the fifth row to scanning line Gm−4 of the row m−4 is formed.

FIG. 5A is a timing chart describing various signals for displaying the above-described first field image (here, referred to as a line pair image). When line pair scanning is performed with the electro-optical device 20, it is possible to display the first field image, and it is possible for the driving device 50 to produce various signals enabling these. As shown in FIG. 5A, two systems that are neighboring each other from the m-system control pulses R1, R2, . . . , Rm have segments that mutually overlap. Then, in the period in which the two systems of control pulse R neighboring each other overlap, enable signals supplied to each of the second AND circuits 130 corresponding the control pulses R are set to an active level at the same time. For example, in the period in which the control pulse R1 and the control pulse R2 overlap, an enable 1 signal ENBY1 and an enable signal 2 ENBY2 are set to the active level at the same time, and in a period in which the control pulse R3 and the control pulse R4 overlap, an enable 3 signal 3 ENBY and an enable signal 4 ENBY 4 are set to the active level at the same time. In this way, scanning signals supplied to the two scanning lines 462 neighboring one another are set to the active level at the same time, and line pair scanning is realized.

The clock signal CLY supplied to the scanning line driving circuit 441 is an alternating potential in which a low potential (for example, a negative power source potential Vss) and a high potential (for example, a positive power source potential Vdd) are periodically repeated, and the scanning line driving circuit 441 generates a scanning signal using such a rectangular wave clock signal CLY. As shown in FIG. 5A, when an image is formed with line pair scanning, in the scanning signal forming the first field image, the clock signal CLY switches from the high potential to the low potential in the period of the selection state. Specifically, the first field image is formed by setting the first scanning line 462 (in the example of the present embodiment, scanning line G5 of the fifth row) and the second scanning line 462 (in the example of the present embodiment, scanning line G6 of the sixth row) to the selection state, and supplying a first image signal (in the example of the present embodiment, image signal V1j of the first row of the frame image) corresponding to the first pixel 48 to the first pixel 48 (in the example of the present embodiment, pixel 48 connected to the scanning line G5 of the fifth row) and the second pixel 48 (in the example of the present embodiment, pixel 48 connected to the scanning line G6 of the sixth row) in the first selection period (for example, period in which the scanning line G5 of the fifth row and scanning line G6 of the sixth row are selected at the same time), setting the third scanning line 462 (in the example of the present embodiment, scanning line G7 of the seventh row) and the fourth scanning line 462 (in the example of the present embodiment, scanning line G8 of the eighth row) to the selection state and supplying a third image signal (in the example of the present embodiment, image signal V3j of the third row of the frame image) corresponding to the third pixel 48 to the third pixel 48 (in the example of the present embodiment, pixel 48 connected to the scanning line G7 of the seventh row) and the fourth pixel 48 (in the example of the present embodiment, pixel 48 connected to the scanning line G8 of the eighth row) in a second selection period subsequent to the first selection period (in the example of the present embodiment, period in which scanning line G7 of the seventh row and scanning line G8 of the eighth row are selected at the same time), and the clock signal switches from the high potential to the low potential in the first selection period and the second selection period.

FIG. 6A is a timing chart of a case of forming a line pair image using shifted line pair scanning; FIG. 6B describes the type of signal supplied to the pixel 48 connected to the scanning line 462 in this case.

FIG. 6B shows an image signal supplied to the signal lines 464 for each row when displaying an even numbered image on the electro-optical device 20 using shifted line pair scanning. Since the second field image is an even numbered image when the first field image is an odd numbered image, and an odd numbered image when the first field image is an even numbered image, here, the second field image is an even numbered image. The even numbered image is an image formed using image signals of even numbered rows from in one frame image which is a source (in the present embodiments, a full high vision image of 1080 vertical pixels×1920 horizontal pixels). In other words, an image in which an image displaying even numbered rows is selected from the frame image is an even numbered image. In the present embodiment, an even numbered image is formed using 540 rows worth of even numbered rows of image signals, such as an image signal V2j of the second row of the frame image, an image signal V4j of the fourth row of the frame image, and an image signal V6j of the sixth row of the frame image. In this case, as shown in FIG. 6B, the same image signal is supplied to the pixels 48 connected to scanning lines 462 in which the scanning lines 462 combined in the case of the previous line pair scanning from two adjacent scanning lines 462 are shifted by one row. For example, the image signal V2j of the second row of the frame image is supplied to the pixel 48 connected to the scanning line G6 of the sixth row and the scanning line G7 of the seventh row, the image signal V4j of the fourth row of the frame image is supplied to the pixel 48 connected to the scanning line G8 of the eighth row and the scanning line G9 of the ninth row, and in the same manner as below, image signal V1080j of the 1080-th row of the frame image is supplied to the pixel 48 connected to the scanning line G1084 of the 1084-th row and the scanning line G1085 of the 1085-th row. Moreover, in FIG. 6B, the adjustment region is a region in which a pixel 48 is connected to scanning lines 462 from scanning line G1 of the first row to scanning line G5 of the fifth row, and a pixel 48 connected to scanning lines 462 from scanning line Gm−2 of the row m−2 to the scanning line Gm of row m, and the image region is a region in which a pixel 48 connected to scanning lines 462 from scanning line G6 of the sixth row to scanning line Gm−3 of the row m−3 is formed. Similarly to the previous, a black signal Black is supplied to the pixels 48 of the adjustment region. In this way, the second field image (in the present embodiment, an even numbered image) is shifted down by one scanning line with respect to the first field image (in the present embodiment, an odd numbered image), and it is possible to reliably display a high definition frame image using time division. That is, as a result of the scanning lines 462 being selected two at a time in the first field image and the second field image, it becomes possible to display a high definition image in a short time.

FIG. 6A is a timing chart describing various signals for displaying the above-described second field image (here, referred to as a shifted line pair image). When shifted line pair scanning is performed with the electro-optical device 20, it is possible to display the second field image, and it is possible for the driving device 50 to produce various signals enabling these.

The control device 30 is able to temporally shift the start pulse signal (DY in FIG. 5A) during line pair scanning and the start pulse signal (DY in FIG. 6A) during shifted line pair scanning by an integer multiple of half the horizontal scanning period of the line pair scanning and the shifted line pair scanning. As can be seen from the signal supplied from the scanning line G1 to scanning line Gm in FIG. 5A, the horizontal scanning period of the line pair scanning is one period of the clock signal CLY. Accordingly, half of the horizontal scanning period is a half-period of the clock signal CLY, and the control device 30 is able to shift the start pulse signal during shifted line pair scanning forwards or backwards by an integer multiple of a half-period of the clock signal CLY with respect to the start pulse signal during line pair scanning. In practice, the start pulse signal (DY in FIG. 6A) during shifted line pair scanning is delayed by one half-period of the clock signal CLY with respect to the start pulse signal (DY in FIG. 5A) during line pair scanning.

Furthermore, the control device 30 is able to set the clock signal (CLY in FIG. 5A) during line pair scanning and the clock signal (CLY in FIG. 6A) during shifted line pair scanning to the same period, and to make the phases different. In practice, the phase of the clock signal (CLY in FIG. 6A) during shifted line pair scanning is shifted by 180° with respect to the clock signal (CLY in FIG. 5A) during line pair scanning in the same period. As a result, when the clock signal (CLY in FIG. 5A) during line pair scanning has a high potential, the clock signal (CLY in FIG. 6A) during shifted line pair scanning has a low potential, and when the clock signal (CLY in FIG. 5A) during line pair scanning has a low potential, the clock signal (CLY in FIG. 6A) during shifted line pair scanning has a high potential.

Furthermore, the control device 30 is able to make the enable signal (ENBY1, ENBY2, ENBY3, and ENBY4 in FIG. 5A) during line pair scanning and the enable signal (ENBY1, ENBY2, ENBY3, and ENBY4 in FIG. 6A) during shifted line pair scanning different. Specifically, the control device 30 is able to change the timing at which the enable signal becomes active according to the scanning method, such as progressive scanning, line pair scanning or shifted line pair scanning. The control device 30 is able to arbitrarily set the high potential state with the enable 1 signal ENBY1, the enable 2 signal ENBY2, the enable 3 signal ENBY3 and the enable 4 signal ENBY 4. In practice, in the enable signal (ENBY1, ENBY2, ENBY3, and ENBY4 in FIG. 5A) during line pair scanning, the enable 1 signal ENBY1 and the enable 2 signal ENBY2 form a pair, the enable 3 signal ENBY3 and the enable 4 signal ENBY4 form a pair, and the respective pairs have the same signal; however, in the enable signal (ENBY1, ENBY2, ENBY3, and ENBY4 in FIG. 6A) during shifted line pair scanning, the enable 1 signal ENBY1 and the enable 4 signal ENBY4 form a pair and the enable 2 signal ENBY2 and the enable 3 signal ENBY3 form a pair.

As a result of such a control signal, the scanning lines 462 forming the pair are shifted one row in the line pair scanning and the shifted line pair scanning. In addition thereto, the second field image is formed by supplying the image signal shown in FIG. 6B according to the row. As shown in FIG. 6A, when an image is formed with shifted line pair scanning, in the scanning signals forming the second field image, the clock signal CLY switches from the low potential to the high potential in the period of the selection state. Specifically, the second field image is formed by setting the second scanning line 462 (in the example of the present embodiment, scanning line G6 of the sixth row) and the third scanning line 462 (in the example of the present embodiment, scanning line G7 of the seventh row) to the selection state, and supplying a second image signal (in the example of the present embodiment, image signal V2j of the second row of the frame image) corresponding to the second pixel 48 to the second pixel 48 (in the example of the present embodiment, pixel 48 connected to the scanning line G6 of the sixth row) and the third pixel 48 (in the example of the present embodiment, pixel 48 connected to the scanning line G7 of the seventh row) in the third selection period (for example, period in which the scanning line G6 of the sixth row and scanning line G7 of the seventh row are selected at the same time), setting the fourth scanning line 462 (in the example of the present embodiment, scanning line G8 of the eighth row) and the fifth scanning line 462 (in the example of the present embodiment, scanning line G9 of the ninth row) to the selection state and supplying an image signal (in the example of the present embodiment, image signal V4j of the fourth row of the frame image) corresponding to the fourth pixel 48 to the fourth pixel 48 (in the example of the present embodiment, pixel 48 connected to the scanning line G8 of the eighth row) and the fifth pixel 48 (in the example of the present embodiment, pixel 48 connected to the scanning line G9 of the ninth row) in a fourth selection period subsequent to the third selection period (in the example of the present embodiment, period in which scanning line G8 of the eighth row and scanning line G9 of the ninth row are selected at the same time), and the clock signal CLY switches from the low potential to the high potential in the period of the third selection state and the fourth selection state.

The present inventors, as a result of thorough research, have found that the switching direction of the clock signal is the same in a case of displaying a first image and in a case of displaying a second image in a display method of the related art as disclosed in JPA-2012-49645, and have determined that this is a cause of a decrease in display quality. In general, when the clock signal switches, a large charge-discharge current is momentarily generated according to the circuit pattern, and there is concern of a positive power source potential and a negative power source potential fluctuating. If such a situation occurs, the image signal supplied to the pixel fluctuates at that moment and, as a result, correct display is not performed. In the display method of the related art, in the first image and in the second image, the clock signal switches from the high potential to the low potential in the middle of the selection period of the scanning signal, and therefore vertical banding in which the brightness changes in the vicinity of the display region in the horizontal direction is generated.

In contrast, in the present embodiment, as described above, since the switching direction of the clock signal CLY is opposite between the first field image and the second field image, it is possible to cancel out the influence of the clock signal CLY switching in the first field image and the second field image. Although there is concern of the brightness changing in the vicinity of the center of the display region in the horizontal direction in the first field image and in the second field image, since the switching directions of the clock signal CLY are opposite, even if a brightness change is generated, the brightness change in the first field image and the brightness change in the second field image are opposite and the influences thereof cancel each other out. Thus, when the driving method of the disclosure in the present embodiment is employed, the generation of vertical banding in which the brightness changes in the vicinity of the center of the display region in the horizontal direction is suppressed, and the image quality improves. That is, it becomes possible to achieve both high speed display of a high definition image and a high quality video image.

Moreover, as shown in FIGS. 5A and 6A, the control signal has a plurality of output patterns. The control device 30 supplies a control signal that is an optimal output pattern from a plurality of output patterns to the driving circuit 44 according to whether the image to be displayed is the first field image or the second field image.

### Display Method

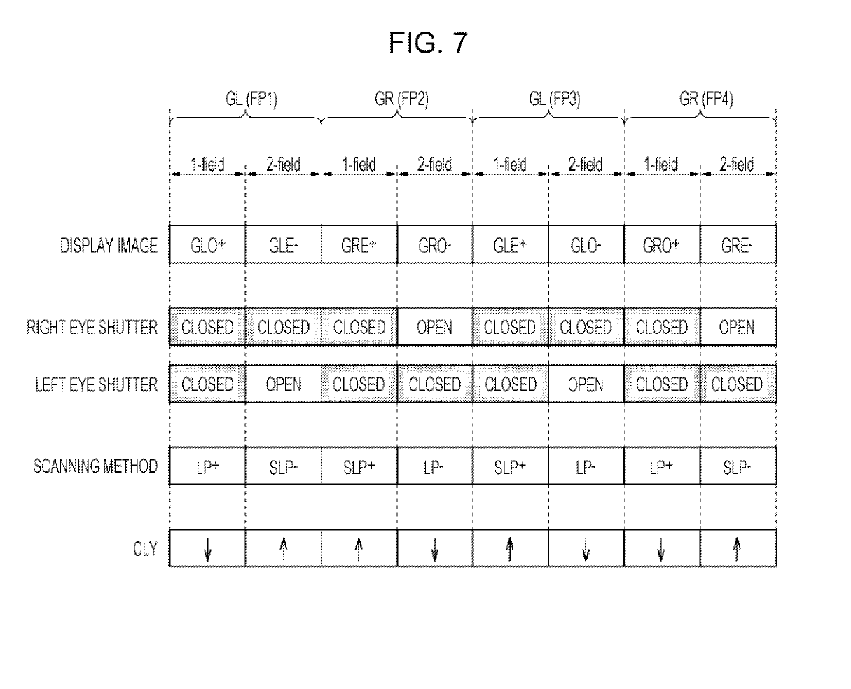

FIG. 7 is a drawing describing a frame image and a method of displaying a three-dimensional image with the electronic equipment using the frame image. Next, the display method of a high definition frame image and a display method of a three-dimensional image to which this is applied will be described with reference to FIG. 7.

As shown in FIG. 7, in displaying a three-dimensional image, a left eye frame image GL and a right eye frame image GR are alternately displayed, and description related to the frame images will be made first. An image configuring one frame (one frame image) is configured to include the first field image and the second field image. In the present embodiment, one period is formed from four frame images (first frame image FP1, second frame image FP2, third frame image FP3, and fourth frame image FP4). In any of the frame images a first field image 1-field is formed followed by a second field image 2-field. In FIG. 7, line pair scanning is denoted by LP and shifted line pair scanning is denoted by SLP in the driving method column.

The first field image 1-field and the second field image 2-field are formed from an image of which an electric field has a positive polarity and an image of which an electric field has a negative polarity, with both electric fields being applied to the liquid crystal 485. The electric field applied to the liquid crystal 485 having positive polarity indicates a state in which the potential of the pixel electrode 481 is set to the potential of the common electrode 483 or higher, when an image signal is supplied to the pixel electrode 481. Conversely, electric field applied to the liquid crystal 485 having negative polarity indicates a state in which the potential of the pixel electrode 481 is set to the potential of the common electrode 483 or lower, when an image signal is supplied to the pixel electrode 481. In FIG. 7, in the display image or scanning method columns, a case of positive polarity is given the reference symbol +, and a case of negative polarity is given the reference symbol −. As shown in FIG. 7, if a first field image 1-field is displayed with positive polarity, a second field image 2-field is displayed with negative polarity. Naturally, conversely, when the first field image 1-field is displayed with negative polarity, the second field image 2-field may be displayed with positive polarity.

In FIG. 7, for the first frame image FP1, a left eye positive polarity odd numbered image GLO+ is displayed as a first field image 1-field through line pair scanning LP+, and a left eye negative polarity even numbered image GLE− is displayed as a second field image 2-field through shifted line pair scanning SLP−. The left eye shutter opens in the period in which the second field image 2-field is formed. The clock signal CLY in the period in which the first field image 1-field is formed switches from the high potential to the low potential (referred to as falling, indicated by a downward arrow in FIG. 7), the clock signal CLY in the period in which the second field image 2-field is formed switches from the low potential to the high potential (referred to as rising, indicated by an upward arrow in FIG. 7), and the influence of the clock signals CLY is canceled out in the frame image.

For the second frame image FP2, a right eye positive polarity even numbered image GRE+ is displayed as a first field image 1-field through shifted line pair scanning SLP+, and a right eye negative polarity odd numbered image GRO− is displayed as a second field image 2-field through line pair scanning. The right eye shutter opens in the period in which the second field image 2-field is formed. The clock signal CLY in the period in which the first field image 1-field is formed rises, the clock signal CLY in the period in which the second field image 2-field is formed falls, and the influence of the clock signals CLY is canceled out in the frame image. In this way, in the second frame image FP2, in the scanning signal forming the first field image 1-field, the clock signal CLY switches from the low potential to the high potential during the period of the selection state, and in the scanning signal forming the second field image 2-field, the clock signal CLY switches from the high potential to the low potential during the period of the selection state. In short, in the first selection period and the second selection period, the clock signal CLY switches from the low potential to the high potential, and, in the third selection period and the fourth selection period, the clock signal CLY switches from the high potential to the low potential.

For the third frame image FP3, a left eye positive polarity even numbered image GLE+ is displayed as a first field image 1-field through shifted line pair scanning SLP+, and a left eye negative polarity odd numbered image GLO− is displayed as a second field image 2-field through line pair scanning LP−. The left eye shutter opens in the period in which the second field image 2-field is formed. The clock signal CLY in the period in which the first field image 1-field is formed rises, the clock signal CLY in the period in which the second field image 2-field is formed falls, and the influence of the clock signals CLY is canceled out in the frame image. In the third frame image FP3, in the scanning signal forming the first field image 1-field, the clock signal CLY switches from the low potential to the high potential during the period of the selection state, and in the scanning signal forming the second field image 2-field, the clock signal CLY switches from the high potential to the low potential during the period of the selection state. In short, in the first selection period and the second selection period, the clock signal CLY switches from the low potential to the high potential, and, in the third selection period and the fourth selection period, the clock signal CLY switches from the high potential to the low potential.

For the fourth frame image FP4, a right eye positive polarity odd numbered image GRO+ is displayed as the first field image 1-field through line pair scanning LP+, and a right eye negative polarity even numbered image GRE− is displayed as the second field image 2-field through shifted line pair scanning SLP−. The right eye shutter opens in the period in which the second field image 2-field is formed. The clock signal CLY in the period in which the first field image 1-field is formed falls, the clock signal CLY in the period in which the second field image 2-field is formed rises, and the influence of the clock signals CLY is canceled out in the frame image.

As shown in FIG. 7, when a driving method in which one period is formed of four frame images, it is possible to attain polarity balance, and to suppress burning in of the image. In addition, it is possible to reduce flickering (flickering of the display image) by alternately repeating the positive polarity and the negative polarity.

### Additional Electronic Equipment

Although the electro-optical device 20 is driven with the above-described driving method, examples of the electronic equipment to which the electro-optical device 20 is incorporated include a rear projection-type television, a direct-view television, a portable telephone, a portable audio device, a personal computer, a monitor for a video camera, a car navigation device, a pager, an electronic notebook, a calculator, a word processor, a workstation, a video telephone, a POS terminal, and a digital still camera, in addition to the projector described with reference to FIG. 1.

### Embodiment 2

### Form Using Interlaced Scanning

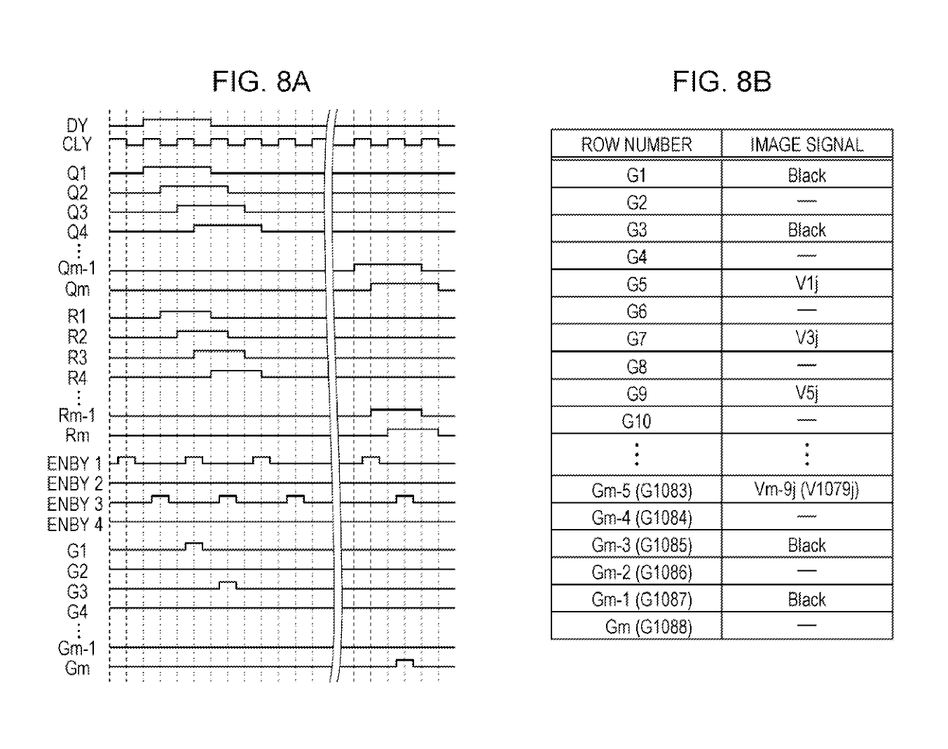

FIGS. 8A and 8B are diagrams describing various signals and display images supplied to an electro-optical device when forming an interlaced image in the present embodiment. Next, a method of forming a first field image using shifted line pair scanning, and forming a second field image using interlaced scanning will be explained with reference to FIGS. 6A and 6B and FIGS. 8A and 8B. Moreover, the same constituent parts as Embodiment 1 are given the same reference symbols and overlapping description will not be made.

The present embodiment differs from Embodiment 1 on the point of using interlaced scanning in place of line pair scanning. Other configurations are substantially the same as Embodiment 1. In Embodiment 1 (FIGS. 5A and 5B and FIGS. 6A and 6B) a line pair image and a shifted line pair image are used in the first field image and the second field image. In contrast, in the present embodiment (FIGS. 6A and 6B and FIGS. 8A and 8B), the first field image is formed using shifted line pair scanning, and the second field image is formed using interlaced scanning.

The first field image formed using shifted line pair scanning is the same as in Embodiment 1 (FIGS. 6A and 6B). That is, the first field image is formed by setting the second scanning line 462 and the third scanning line 462 to the selection state and supplying a second image signal corresponding to the second pixel 48 to the second pixel 48 and the third pixel 48 in a selection period −1, setting the fourth scanning line 462 and the fifth scanning line 462 to the selection state and supplying an image signal corresponding to the fourth pixel 48 to the fourth pixel 48 and the fifth pixel 48 in a selection period −2 subsequent to the selection period −1, and the clock signal CLY switches from the low potential to the high potential in the selection period −1 and the selection period −2. In contrast, in the present embodiment, the display method of the second field image is different. These will be described next.

FIG. 8A is a timing chart of a case of forming a second field image using interlaced scanning, and FIG. 8B describes the types of signal supplied to the pixels 48 connected to the scanning lines 462 in this case. As shown in FIGS. 8A and 8B, interlaced scanning is a display method in which every other scanning line 462 is selected during field image formation, and image signals are rewritten in the pixels 48 connected to the selected scanning lines 462. That is, in the second field image, approximately half of the display region is rewritten with a new image. In the present embodiment, the image signal is supplied to the pixel 48 connected to the scanning lines 462 of the odd numbered rows without the scanning lines 462 of the even numbered rows being selected.

FIG. 8B shows an image signal supplied to the signal lines 464 for each row when displaying an odd numbered image on the electro-optical device 20 using interlaced scanning. Since the first field image shown in FIGS. 6A and 6B is an even numbered image, the second field image is an odd numbered image. In this case, as shown in FIG. 8B, the image signal is supplied to the pixel 48 connected to the scanning lines 462 for every other scanning line 462. For example, the image signal V1j of the first row of the frame image is supplied to the pixel 48 connected to the scanning line G5 of the fifth row, and the image signal V3j of the third row of the frame image is supplied to the pixel 48 connected to the scanning line G7 of the seventh row, and in the same manner as below, image signal V1079j of the 1079-th row of the frame image is supplied to the pixel 48 connected to the scanning line G1083 of the 1083-rd row. Similarly to Embodiment 1, four scanning lines worth of adjustment region is provided above and below the image region. An image signal is supplied to the pixels 48 of the image region, and a black signal Black is supplied to the pixels 48 of the adjustment region. In FIG. 8B, the adjustment region is a region in which a pixel 48 connected to scanning lines 462 from scanning line G1 of the first row to scanning line G4 of the fourth row, and a pixel 48 connected to scanning lines 462 from scanning line Gm−3 of the row m−3 to the scanning line Gm of row m are formed, and the image region is a region in which a pixel 48 connected to scanning lines 462 from scanning line G5 of the fifth row to scanning line Gm−4 of the row m−4 is formed.

FIG. 8A is a timing chart describing the various signals for displaying the above-described second field image. When interlaced scanning is performed with the electro-optical device 20, it is possible to display the second field image, and it is possible for the driving device 50 to produce various signals enabling these. As shown in FIG. 8A, two systems neighboring each other from the m-system control pulses R1, R2, . . . , Rm have segments that mutually overlap. Then, in the period in which the two systems of control pulse R neighboring each other overlap, enable signals ENBY supplied to each of the second AND circuits 130 corresponding the control pulses R are set to the active level at the same time. For example, in the period in which the control pulse R1 and the control pulse R2 overlap, the enable 1 signal ENBY1 is set to the active level, and the scanning line G1 of the first row is selected. Similarly, in the period in which the control pulse R3 and the control pulse R4 overlap, the enable 3 signal ENBY3 is set to the active level, and the scanning line G3 of the third row is selected. In this way, the enable 2 signal ENBY 2 and the enable 4 signal ENBY 4 maintain an inactive state, and the enable 1 signal ENBY1 and the enable 3 signal ENBY 3 alternately becomes active at every cycle of the clock signal CLY. In this way, the every other scanning signal supplied to the scanning line 462 is sequentially set to the selection state, and interlaced scanning is realized.

As shown in FIG. 8A, when an image is formed with interlaced scanning, in the scanning signal forming the second field image, the clock signal CLY switches from the high potential to the low potential in the period of the selection state. Specifically, the second field image formed using interlaced scanning is formed by setting the first scanning line 462 (in the example of the embodiment, scanning line G5 of the fifth row) to the selection state and supplying a first image signal (in the example of the embodiment, image signal V1j of the first row of the frame image) corresponding to the first pixel 48 to the first pixel 48 (in the example of the embodiment, the pixel 48 connected to the scanning line G5 of the fifth row) in a selection period −3 (in the example of the embodiment, period in which scanning line G5 of the fifth row is selected), the third scanning line 462 (in the example of the embodiment, the scanning line G7 of the seventh row) is set to the selection state, and an image signal (in the example of the embodiment, image signal V3j of the third row of the frame image) corresponding to the third pixel 48 is supplied to the third pixel 48 (in the example of the embodiment, pixel 48 connected to the scanning line G7 of the seventh row) in a selection period −4 subsequent to the selection period −3 (in the example of the embodiment, period in which the scanning line G7 of the seventh row is selected), and the clock signal CLY switches from the high potential to the low potential in the selection period −3 and the selection period −4.

In the embodiment, since the switching direction of the clock signal CLY is opposite between the first field image and the second field image, it is possible to cancel out the influence of the clock signal CLY switching in the first field image and the second field image, and the same effects as in Embodiment 1 are obtained.

### Display Method

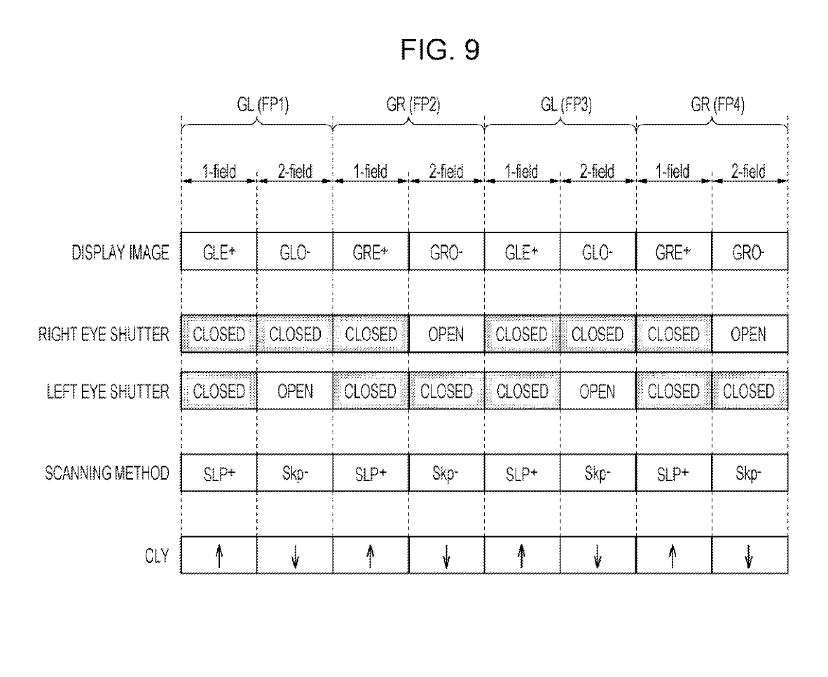

FIG. 9 is a drawing describing a frame image and a method of displaying a three-dimensional image with the electronic equipment using the frame image. Next, the display method of a high definition frame image and a display method of a three-dimensional image to which this is applied will be described with reference to FIG. 9.

As shown in FIG. 9, in displaying a three-dimensional image, a left eye frame image GL and a right eye frame image GR are alternately displayed, and description related to the frame images will be made first.

An image configuring one frame (one frame image) is configured to include the first field image and the second field image. In FIG. 9, four frame images (first frame image FP1, second frame image FP2, third frame image FP3 and fourth frame image FP4) are drawn. In any of the frame images, a first field image 1-field is formed followed by a second field image 2-field. In FIG. 9, interlaced scanning is denoted by Skp and shifted line pair scanning is denoted by SLP in the scanning method column.

The first field image 1-field and the second field image 2-field are formed from an image of which an electric field has a positive polarity and an image of which an electric field negative polarity, with both electric fields being applied to the liquid crystal 485. In FIG. 9, in the display image or scanning method columns, a case of positive polarity is given the reference symbol +, and a case of negative polarity is given the reference symbol −. As shown in FIG. 9, if a first field image 1-field is displayed with positive polarity, a second field image 2-field is displayed with negative polarity. Naturally, conversely, when the first field image 1-field is displayed with negative polarity, the second field image 2-field may be displayed with positive polarity.

As shown in FIG. 9, for the first frame image FP1, a left eye positive polarity even numbered image GLE+ is displayed as a first field image 1-field through shifted line pair scanning SLP+, and a left eye negative polarity odd numbered image GLO− is displayed as a second field image 2-field through interlaced scanning Skp−. The left eye shutter opens in the period in which the second field image 2-field is formed. The clock signal CLY in the period in which the first field image 1-field is formed rises, the clock signal CLY in the period in which the second field image 2-field is formed falls, and the influence of the clock signals CLY is canceled out in the frame image.

For the second frame image FP2, a right eye positive polarity even numbered image GRE+ is displayed as a first field image 1-field through shifted line pair scanning SLP+, and a right eye negative polarity odd numbered image GRO− is displayed as a second field image 2-field through interlaced scanning Skp−. The right eye shutter opens in the period in which the second field image 2-field is formed. The clock signal in the period in which the first field image 1-field is formed rises, the clock signal CLY in the period in which the second field image 2-field is formed falls, and the influence of the clock signals CLY is canceled out in the frame image.

Below, the odd numbered frame images are formed similarly to the first frame image FP1, and the even numbered frame images are formed similarly to the second frame image FP2. In this way, in the present embodiment, in the scanning signal forming the first field image 1-field, the clock signal CLY switches from the low potential to the high potential during the period of the selection state, and in the scanning signal forming the second field image 2-field, the clock signal CLY switches from the high potential to the low potential during the period of the selection state. In short, the clock signal CLY switches from the low potential to the high potential in the selection period −3 and the selection period −4 appearing during second field image 2-field formation, and the clock signal CLY switches from the high potential to the low potential in the selection period −1 and the selection period −2 appearing during first field image 1-field formation.

Moreover, in the embodiment, although the even numbered images are formed using shifted line pair scanning SLP and the odd numbered images are formed using interlaced scanning Skp, conversely thereto, the odd numbered images may be formed using shifted line pair scanning SLP and the even numbered images may be formed using interlaced scanning Skp. In addition, the configuration may switch the clock signal CLY from the low potential to the high potential in the selection period −3 and the selection period −4, and switch the clock signal CLY from the high potential to the low potential in the selection period −1 and the selection period −2.

Here, the invention is not limited to the above-mentioned embodiments, and various modifications, improvements, and the like can be added to the above-mentioned embodiments.

This application claims priority to Japan Patent Application No. 2012-277753 filed Dec. 20, 2012, the entire disclosures of which are hereby incorporated by reference in their entireties.

What is claimed is:

1. A driving method of an electro-optical device, which includes a pixel and a scanning line driving circuit supplying a scanning signal to the pixel,
wherein the scanning signal has a selection state and a non-selection state;
the scanning line driving circuit generates a scanning signal using a clock signal in which a low potential and a high potential are repeated,
one frame image includes a first field image and a second field image,
the clock signal switches from the high potential to the low potential during the period of the selection state in the scanning signal forming the first field image, and
the clock signal switches from the low potential to the high potential in the period of the selection state in the scanning signal forming the second field image.

2. A driving method of an electro-optical device, which includes a pixel and a scanning line driving circuit supplying a scanning signal to the pixel,
wherein the scanning signal has a selection state and a non-selection state,
the scanning line driving circuit generates a scanning signal using a clock signal in which a low potential and a high potential are repeated,
one frame image includes a first field image and a second field image,
the clock signal switches from the low potential to the high potential during the period of the selection state in the scanning signal forming the first field image, and
the clock signal switches from the high potential to the low potential in the period of the selection state in the scanning signal forming the second field image.

3. The driving method of an electro-optical device according to claim 1, further comprising:
a scanning line electrically connected to the scanning line driving circuit,
wherein the first field image is formed using a line pair scanning in which each line pair is selected, with a set of two adjacent scanning lines of the scanning lines as a line pair, and
the second field image is formed using a shifted line pair scanning in which each shifted line pair is selected with a set of scanning lines different from the line pair having two adjacent scanning lines of the scanning lines as a shifted line pair.

4. A driving method of an electro-optical device which includes a first scanning line, and a first pixel connected to the first scanning line; a second scanning line adjacent to the first scanning line, and a second pixel connected to the second scanning line; a third scanning line adjacent to the second scanning line, and a third pixel connected to the third scanning line; a fourth scanning line adjacent to the third scanning line, and a fourth pixel connected to the fourth scanning line; a fifth scanning line adjacent to the fourth scanning line, and a fifth pixel connected to the fifth scanning line: and signal lines supplying image signals to the first pixel, the second pixel, the third pixel, the fourth pixel and the fifth pixel,
wherein a frame image configuring one frame includes a first field image and a second field image,
the first field image is formed by setting the first scanning line and the second scanning line to the selection state, and supplying a first image signal corresponding to the first pixel to the first pixel and the second pixel, in a first selection period, and by setting the third scanning line and the fourth scanning line to a selection state, and supplying a third image signal corresponding to the third pixel to the third pixel and the fourth pixel in a second selection period subsequent to the first selection period,
the second field image is formed by setting the second scanning line and the third scanning line to the selection state and supplying a second image signal corresponding to the second pixel to the second pixel and the third pixel in a third selection period, and by setting the fourth scanning line and the fifth scanning line to the selection state and supplying an image signal corresponding to the fourth pixel to the fourth pixel and the fifth pixel in a fourth selection period subsequent to the third selection period,
the selection state is generated according to a clock signal in which a low potential and a high potential are repeated,
the clock signal switches from the high potential to the low potential in the first selection period and the second selection period, and
the clock signal switches from the low potential to the high potential in the third selection period and the fourth selection period.

5. A driving method of an electro-optical device which includes a first scanning line, and a first pixel connected to the first scanning line; a second scanning line adjacent to the first scanning line, and a second pixel connected to the second scanning line; a third scanning line adjacent to the second scanning line, and a third pixel connected to the third scanning line; a fourth scanning line adjacent to the third scanning line, and a fourth pixel connected to the fourth scanning line; a fifth scanning line adjacent to the fourth scanning line, and a fifth pixel connected to the fifth scanning line; and signal lines supplying image signals to the first pixel, the second pixel, the third pixel, the fourth pixel, and the fifth pixel,
wherein a frame image configuring one frame includes a first field image and a second field image,
the first field image is formed by setting the first scanning line and the second scanning line to the selection state, and supplying a first image signal corresponding to the first pixel to the first pixel and the second pixel, in a first selection period, and by setting the third scanning line and the fourth scanning line to a selection state, and supplying a third image signal corresponding to the third pixel to the third pixel and the fourth pixel in a second selection period subsequent to the first selection period,
the second field image is formed by setting the second scanning line and the third scanning line to the selection state and supplying a second image signal corresponding to the second pixel to the second pixel and the third pixel in a third selection period, and by setting the fourth scanning line and the fifth scanning line to the selection state and supplying an image signal corresponding to the fourth pixel to the fourth pixel and the fifth pixel in a fourth selection period subsequent to the third selection period,
the selection state is generated according to a clock signal in which a low potential and a high potential are repeated;
the clock signal switches from the low potential to the high potential in the first selection period and the second selection period, and
the clock signal switches from the high potential to the low potential in the third selection period and the fourth selection period.

6. The driving method of an electro-optical device according to claim 1, further comprising:
a scanning line electrically connected to the scanning line driving circuit,
wherein the first field image is formed using shifted line pair scanning in which each shifted line pair is selected with a set of two adjacent scanning lines of the scanning lines as a shifted line pair, and
the second field image is formed using interlaced scanning in which every other scanning line is selected.

7. A driving method of an electro-optical device which includes a first scanning line, and a first pixel connected to the first scanning line; a second scanning line adjacent to the first scanning line, and a second pixel connected to the second scanning line; a third scanning line adjacent to the second scanning line, and a third pixel connected to the third scanning line; a fourth scanning line adjacent to the third scanning line, and a fourth pixel connected to the fourth scanning line; a fifth scanning line adjacent to the fourth scanning line, and a fifth pixel connected to the fifth scanning line; and signal lines supplying image signals to the first pixel, the second pixel, the third pixel, the fourth pixel and the fifth pixel,
wherein a frame image configuring one frame includes a first field image and a second field image,
the first field image is formed by setting the second scanning line and the third scanning line to the selection state, and supplying a second image signal corresponding to the second pixel to the third pixel and the second pixel, in a selection period −1, and by setting the fourth scanning line and the fifth scanning line to a selection state, and supplying an image signal corresponding to the fourth pixel to the fourth pixel and the fifth pixel in a selection period −2 subsequent to the selection period −1,
the second field image is formed by setting the first scanning line to the selection state and supplying a first image signal corresponding to the first pixel to the first pixel in a selection period −3, and by setting the third scanning line to the selection state and supplying an image signal corresponding to the third pixel to the third pixel in a selection period −4 subsequent to the selection period −3,
the selection state is generated according to a clock signal in which a low potential and a high potential are repeated,
the clock signal switches from the high potential to the low potential in the selection period −3 and the selection period −4, and
the clock signal switches from the low potential to the high potential in the selection period −1 and the selection period −2.

8. A driving method of an electro-optical device which includes a first scanning line, and a first pixel connected to the first scanning line; a second scanning line adjacent to the first scanning line, and a second pixel connected to the second scanning line; a third scanning line adjacent to the second scanning line, and a third pixel connected to the third scanning line; a fourth scanning line adjacent to the third scanning line, and a fourth pixel connected to the fourth scanning line; a fifth scanning line adjacent to the fourth scanning line, and a fifth pixel connected to the fifth scanning line; and signal lines supplying image signals to the first pixel, the second pixel, the third pixel, the fourth pixel and the fifth pixel,
wherein a frame image configuring one frame includes a first field image and a second field image,
the first field image is formed by setting the second scanning line and the third scanning line to the selection state, and supplying a second image signal corresponding to the second pixel to the second pixel and the third pixel, in a selection period −1, and setting the fourth scanning line and the fifth scanning line to a selection state, and supplying an image signal corresponding to the fourth pixel to the fourth pixel and the fifth pixel in a selection period −2 subsequent to the selection period −1,
the second field image is formed by setting the first scanning line to the selection state and supplying a first image signal corresponding to the first pixel to the first pixel in a selection period −3, and by setting the third scanning line to the selection state and supplying an image signal corresponding to the third pixel to the third pixel in a selection period −4 subsequent to the selection period −3,
the selection state is generated according to a clock signal in which a low potential and a high potential are repeated,
the clock signal switches from the low potential to the high potential in the selection period −3 and the selection period −4, and
the clock signal switches from the high potential to the low potential in the selection −1 period and the selection period −2.

9. A driving device realizing the driving method of an electro-optical device according to claim 1, wherein a signal is supplied to the electro-optical device.

10. An electro-optical device driven by the driving method of an electro-optical device according to claim 1.
